(19) United States
(12) Patent Application Publication
(10) Pub. No.: US 2003/0175554 A1
(43) Pub. Date: Sep. 18, 2003

(54) Magneto-optic recording medium recordable at ultrahigh recording density

(76) Inventor: Toshimori Miyakoshi, Kanagawa (JP)

Correspondence Address: FITZPATRICK CELLA HARPER & SCINTO, 30 ROCKEFELLER PLAZA, NEW YORK, NY, 10112, US

(21) Appl. No.: 10/384,618

(22) Filed: Mar. 11, 2003

(30) Foreign Application Priority Data
Mar. 12, 2002 (JP) 066752/2002

(51) Int. Cl. B32B 9/00

(52) U.S. Cl. 428/693; 428/694 ML

(57) ABSTRACT

There is provided a magneto-optic recording medium which suits the DWDD readout method and enables stable formation of domains even when ultramicromarks are recorded. The magneto-optic recording medium has a memory layer and a switching layer as magnetic films and, when produced, conditions for forming the magnetic films are so surveyed that the product of saturation magnetization Ms and coercive force Hc, MsHc, is maximized. An MsHc (10⁶ erg/cc) of the memory layer is 15.8 (T/Tc−1) or more where temperature is represented by T (K) and Curie temperature of the memory layer by Tc (K).

### BACKGROUND OF THE INVENTION

1. Field of the Invention

This invention relates to a magneto-optic recording medium for ultrahigh-density recording.

2. Related Background Art

As rewritable recording mediums, various magnetic recording mediums have been put into practical use. In particular, magneto-optic recording mediums in which the heat energy of a semiconductor laser is used to write magnetic domains in a magnetic thin film to record information and the magneto-optic effect is utilized to read this information are expected as large-capacity commutative mediums which can perform high-density recording. In recent years, with the trend of digitization of animated images, there is an increasing demand for the enhancement of recording density of such magnetic recording mediums to provide recording mediums having much larger capacity.

In general, the linear recording density of an optical recording medium depends greatly on the laser wavelength of a readout (or reproduction) optical system and on the numerical aperture NA of an objective lens. More specifically, the diameter of a beam waist depends on the laser wavelength λ of the readout optical system and on the numerical aperture NA of the objective lens. Hence, the spatial frequency of a signal-reproducible memory pit comes inevitably to be about 2NA/λ at maximum. Accordingly, in order to achieve higher recording density in conventional optical disks, it is necessary to make small the laser wavelength of the readout optical system or make large the numerical aperture NA of the objective lens. However, because of efficiency of devices and problems such as heat generation, it is not easy to make the laser wavelength shorter. Also, with an increase in numerical aperture of the objective lens, its focal depth becomes narrower. This may cause a problem that a severe requirement is imposed on mechanical precision. For this reason, what is called a super-resolution technique has been developed in variety, in which the recording density is improved by designing the construction of recording mediums or the manner of readout, without changing the laser wavelength or the numerical aperture of the objective lens.

For example, as disclosed in Japanese Patent Application Laid-Open Nos. 3-93058 and 6-124500, a signal readout method is proposed in which signals are recorded in a multiple-film memory-holding layer having a readout layer and a memory-holding layer which are magnetically coupled and also, after the direction of magnetization of the readout layer is uniformed (in Japanese Patent Application Laid-Open No. 6-124500, the direction of magnetization is in-plane), the multiple-film memory-holding layer is irradiated by laser light and heated to read information while the signals recorded in the memory-holding layer are transferred to the heated regions of the readout layer. According to this method, the regions (apertures) which are heated by the laser to reach the transfer temperature and where the signals are detected can be made smaller than the spot diameter of the laser for readout. Hence, any interference between signs at the time of readout can be lessened, and signals having a pit frequency of λ/2NA or less which is the optical detection limit can be reproduced. This readout method is called an MSR (magnetically-induced super resolution) readout method.

This MSR readout method, however, has a disadvantage that the signal detection regions that are effectively usable are small for the spot diameter of the laser for readout and hence the readout signal amplitude may so vastly lower as to attain no sufficient readout output. For this reason, the effective signal detection regions can not be made so much small for the spot diameter, and eventually any vastly high density can not be achieved in respect to the recording density that depends on the diffraction limit of optical systems.

Accordingly, as disclosed in Japanese Patent Application Laid-Open No. 6-290496, a magneto-optic recording medium and a readout method therefor are proposed in which magnetic domain walls present at boundaries of memory marks are displaced to the high-temperature side by means of temperature gradient and this displacement of magnetic domain walls is detected so that signals having a recording density higher than the resolving power of optical systems can be read out without lowering the readout signal amplitude. This readout method is called a DWDD (domain wall displacement detection) readout method.

In this DWDD readout method, as shown in FIGS. 4A to 4C, the recording medium consists of a first magnetic layer 401 having a small domain wall coercive force, a second magnetic layer 402 having a low Curie temperature and a third magnetic layer 403 having a large domain wall coercive force. As reported in a publication J. Magn. Soc. Jpan., 22, suppl. No. S2, pp. 47-50 (1998), the first magnetic layer 401 functions as a displacement layer (or a readout layer) in which the domain wall displacement takes place at the time of readout, the second magnetic layer 402 functions as a switching layer which controls the position where the domain wall displacement is started, and the third magnetic layer 403 functions as a memory layer which holds information. Where temperature distribution as shown in FIG. 4B is formed on the magnetic-layer surface, distribution of domain wall energy density as shown in FIG. 4C is formed, so that a domain wall drive force is produced which so acts as to displace the domain walls to the low-energy high-temperature side.

In the region having a temperature lower than the Curie temperature of the switching layer, the respective magnetic layers have exchange coupling to one another, the large domain wall coercive force of the memory layer hinders the domain wall displacement from taking place even when the above domain wall drive force acts. However, at the position where the temperature comes to temperature Ts that is vicinal to the Curie temperature of the switching layer, such exchange coupling force weakens, and hence only domain walls in the displacement layer which have small domain wall coercive force displace alone to the high-temperature side. It follows that this displacement of domain walls takes place at time intervals corresponding to the spatial intervals of the domain walls when the medium is relatively displaced in respect to the temperature distribution. Thus, the occurrence of the domain wall displacement may be detected, whereby signals can be read out without relation to the resolving power of optical systems.

Hitherto, in magneto-optic recording mediums, magnetic films have been used which are comprised of amorphous rare earth-transition metal alloys (RE-TM alloys), formed by a sputtering process making use of Ar gas. In particular, a magnetic film composed chiefly of TbFeCo film is in wide use. Then, in a magneto-optic recording medium utilizing this magnetic film, the above super-resolution technique (MSR readout method) is used, whereby a magneto-optic recording medium which enables readout of signals of microscopic memory marks of about 0.2 μm in size has been put into practical use.

Meanwhile, in the DWDD readout method, the recorded information is read out by the displacement of domain walls, and hence the minimum unit of recording can be made small up to the thickness order of the domain walls. Thus, this method has a possibility toward much higher density.

However, magnetic films for magneto-optic recording mediums which have been developed so far do not presuppose their use in the DWDD readout method, and hence they have little taken account of recording and readout performance for ultramicromarks. Especially where the memory mark length is about 0.15 μm or less in the existing TbFeCo magnetic films, lack of memory may occur when recorded or any good jitter value can not be attained, thus there has been a problem that memory marks have insufficient storage stability. Accordingly, in order to make the most of the DWDD readout method and achieve much higher recording density, it has been desired to develop a new magnetic film which enables stable recording and readout of ultramicromarks.

### SUMMARY OF THE INVENTION

The present invention provides a magneto-optic recording medium which solves the above problems the conventional magnetic films have had, suits the DWDD readout method, and enables stable formation of magnetic domains even when ultramicromarks are recorded.

The present inventor has taken note of the magnetic properties of magnetic films, in particular, MsHc, and has discovered a correlation between the MsHc of magnetic films and the minimum mark length at which recording can stably be performed without causing any lack of memory. The larger the MsHc is, the smaller the minimum mark length is. The magneto-optic recording medium of the present invention has a memory layer and a switching layer as magnetic films and, when produced, conditions for forming the magnetic films are so surveyed that the product of saturation magnetization Ms and coercive force Hc (MsHc) is maximized. Marks smaller than 0.15 μm which is the critical magnetic memory mark length of conventional magneto-optic recording mediums can stably be recorded and read out when the MsHc (10⁶ erg/cc) of the memory layer is 15.8 (T/Tc−1)² or more where temperature is represented by T (K) and Curie temperature of the memory layer by Tc (K), and the MsHc of the switching layer is 37.1 (T/Tc−1)² or more where temperature is represented by T (K) and Curie temperature of the switching layer by Tc (K).

### BRIEF DESCRIPTION OF THE DRAWINGS

FIG. 1 illustrates the construction of a magneto-optic recording medium according to an embodiment of the present invention.

FIG. 2 is a graph showing temperature dependence of MsHc of a memory layer.

FIG. 3 is a graph showing temperature dependence of MsHc of a switching layer.

FIGS. 4A, 4B and 4C are diagrammatic illustrations of the DWDD readout method.

### DESCRIPTION OF THE PREFERRED EMBODIMENTS

Embodiments of the present invention are described below with reference to the drawings.

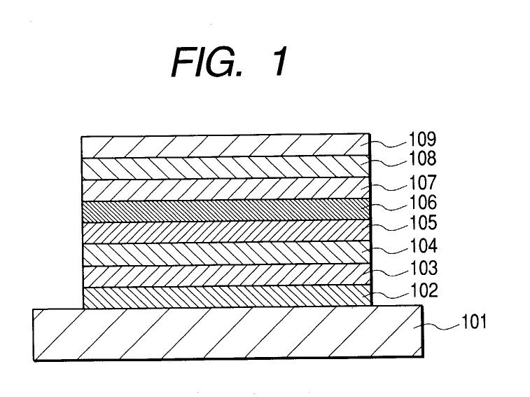

With reference to FIG. 1, the magneto-optic recording medium according to an embodiment of the present invention has a substrate 101, and superposed thereon in order a first dielectric layer 102, a readout layer 103, a readout auxiliary layer 104, a control layer 105, a switching layer 106, a memory layer 107, a memory auxiliary layer 108 and a second dielectric layer 109.

As materials for the substrate 101, polycarbonate, acrylic resin, glass and the like may be used, for example. As materials for the first dielectric layer 102 and second dielectric layer 109, SiN, AlN, SiO, ZnS, MgF, TaO and the like may be used, for example. These also need not necessarily be light-transmissive materials unless the displacement of domain walls is optically detected.

The readout layer 103, the switching layer 106 and the memory layer 107 are three layers indispensable for the DWDD readout. The readout layer 103 has a property that it has a domain wall coercive force smaller than that of the switching layer 106 and memory layer 107; and the switching layer 106, that it has a Curie temperature lower than that of the readout layer 103 and memory layer 107.

Incidentally, the readout auxiliary layer 104 is provided from the viewpoint of improvement of readout performance. It may have construction provided with compositional gradient in the layer thickness direction, or may have multi-layered construction. The control layer 105 controls any surplus domain wall displacement (ghost signals) at the rear-end edges in readout beam spots, and a magnetic layer may be used which is comprised of a TbFeCo or TbDyFeCo system. The memory auxiliary layer 108 makes regulation to improve sensitivity to a modulated magnetic field at the time of recording, and a magnetic film may be used which is comprised of a GdFeCo or GdDyFeCo system.

To such construction, a metal layer formed of Al, AlTa, AlTi, AlCr, AlSi, Cu, Pt, Au or the like may further be added to regulate thermal properties. A protective coat layer formed of a high-polymer resin may also be provided. Alternatively, a substrate on which films have been formed may be laminated. Also, the layers other than magnetic layers, and the order of superposing the magnetic layers may also be in reverse. In addition, the interfaces between the magnetic layer need not necessarily be clear and sharp, and may be so constructed as to change gradually in characteristics in the layer thickness direction.

These layers may be coat-formed by, e.g., continuous sputtering using a magnetron sputtering system or by continuous vacuum deposition. In particular, the respective magnetic layers are continuously film-formed without breaking vacuum so that they have exchange coupling to one another.

The magnetic layers 103 to 108 may be contemplated to be formed of materials used commonly in magnetic recording mediums and magneto-optic recording mediums, and besides various materials such as magnetic bubble materials and anti-ferromagnetic materials. For example, these may be formed of amorphous rare earth-iron family alloys constituted of 10 to 40 at. % of at least one of rare-earth metallic elements such as Pr, Nd, Sm, Eu, Gd, Tb, Dy, Ho and Er and 90 to 60 at. % of at least one of iron family elements such as Fe, Co and Ni. In order to improve corrosion resistance, an element such as Cr, Mn, Cu, Ti, Al, Si, Pt or In may also be added to these alloys in a small quantity. Also usable are platinum group-iron family periodic structural films such as Pt/Co and Pd/Co films, platinum group-iron family alloy films, anti-ferromagnetic materials such as Co—Ni—O and Fe—Rh alloys, and materials such as magnetic garnet.

In the case of amorphous heavy rare earth-iron family alloys, the saturation magnetization may be controlled by selecting compositional ratios of rare-earth elements to iron family elements. In taking the form of the compensating composition, the saturation magnetization at room temperature can be controlled to be 0 emu/cc.

The Curie temperature may also be controlled by selecting compositional ratios. In order to control it independently from the saturation magnetization, a method may preferably be used in which a material composed of Fe part of which has been substituted with Co is used as an iron family element and the amount of substitution is controlled. More specifically, in substituting 1 at. % of the Fe element with Co, the Curie temperature can be expected to rise by about 6° C., and hence this relation is used to regulate the amount of Co so that the Curie temperature may come to the desired temperature. It is also possible to lower the Curie temperature conversely by adding a trace amount of a non-magnetic element such as Cr, Ti or Al. The Curie temperature may also be controlled by using two or more kinds of rare-earth elements and regulating their compositional ratio.

The domain wall coercive force and the domain wall energy density are chiefly controlled by selecting material elements. These may also be regulated by controlling the state of the subbing layer first dielectric layer or by selecting film formation conditions such as sputtering gas pressure. Materials of Tb and Dy types have large anisotropy and high domain wall coercive force or domain wall energy density, and materials of a Gd type have small and low ones. These physical properties may also be controlled by adding impurities.

The layer thickness may be controlled by selecting the rate of film formation and the time of film formation.

The recording of data signals in the magneto-optic recording medium of the present invention is performed by magnetic recording or thermomagnetic recording and by making the state of magnetization orientation of the memory layer correspond to the data signals. The thermomagnetic recording includes a method in which an external magnetic field is modulated displacing the medium and irradiating the medium by laser light having power that may make the memory layer come to the Curie temperature or more, and a method in which laser power is modulated applying a magnetic field having a constant direction. In the case of the latter, the intensity of laser light may be so regulated that only given regions in light spots may come to the Curie temperature or more, whereby memory domains having diameter not larger than the light spots can be formed and a memory pattern having a density higher than the resolving power of optical systems can be formed.

### EXAMPLE

A direct-current magnetron sputtering system was fitted with targets of B-doped Si and also Gd, Tb, FeCr and CoCr, and a polycarbonate substrate in which guide grooves for tracking were formed was fastened to a substrate holder. Then, the inside of a chamber was evacuated by means of a cryopump until it came to a high vacuum of 2×10⁻⁵ Pa or less. Thereafter, Ar gas or Kr gas was fed into the chamber as its inside was kept evacuated, and the targets were sputtered rotating the substrate to form each layer. When a SiN layer is formed, N₂ gas is fed in place of Ar gas to carry out direct-current reactive sputtering to form the film.

In the first place, Ar gas and N₂ gas were made to flow into the chamber and the pressure was set to the desired value by regulating conductance, where an SiN layer was formed as the first dielectric layer in a thickness of 35 nm.

Magnetic films are formed in a chamber different from that for the dielectric layer because any N₂ gas having mingled at the time of its film formation may cause nitriding to affect magnetic properties. After the first dielectric layer was formed, the substrate with that layer was transported to the different chamber, and then Ar gas was fed into it. Its inside was brought to a desired pressure by regulating conductance, where GdFeCoCr layers having different compositional ratios were formed as the readout layer and the readout auxiliary layer each in a layer thickness of 18 nm. Next, 50 sccm of Ar gas was fed into the chamber, and its inside was brought to a pressure of about 1.0 Pa by regulating conductance, where a TbFeCoCr layer was formed as the control layer in a layer thickness of 18 nm, and a TbFeCr layer as the switching layer in a layer thickness of 10 nm.

Before the memory layer was formed, the Ar gas was temporarily stopped being fed, and the inside of the chamber was evacuated to a certain degree. Thereafter, 18 sccm of Kr gas was fed into it, and then the memory layer was formed. The pressure was set to about 0.8 Pa by regulating conductance, and the substrate holder was rotated at a number of revolutions of 35 rpm. Tb, Fe, Co and Cr were used as materials for the memory layer, which was then formed in a layer thickness of 60 nm.

Thereafter, a GdFeCoCr layer was formed as the memory auxiliary layer in a layer thickness of 20 nm, using Ar gas.

Finally, an SiN layer was formed as the second dielectric layer in a layer thickness of 50 nm by direct-current reactive sputtering like that used when the first dielectric layer was formed.

As to the magnetic layers, their compositional ratios were controlled by selecting the proportion of the power applied to the respective targets of Gd, Tb, FeCr and CoCr. The compositional ratios were so regulated that the magnetic layers all had composition vicinal to the compensating composition. Stated strictly, their compositional ratios were so regulated that the rare-earth elements came a little predominant at room temperature so that the rare-earth elements and the iron family elements were compensated at temperature vicinal to the readout temperature Curie temperature of the switching layer. Stated specifically, the Curie temperature of the readout layer was so regulated as to come to about 290° C.; the Curie temperature of the readout auxiliary layer to about 250° C.; the Curie temperature of the control layer to about 170° C.; the Curie temperature of the switching layer to about 160° C.; the Curie temperature of the memory layer to about 330° C.; and the Curie temperature of the memory auxiliary layer to about 380° C.

Dynamic properties of the sample thus prepared (designated as Sample 1) were evaluated using a magneto-optic disk evaluation instrument conventionally commonly used, having a magnetic head for magnetic-field modulation recording and having a laser light wavelength of 680 nm and an objective lens N.A. of 0.55.

In the first place, prior to the recording, a tracking servo was put on the guide grooves of the medium, and the medium was continuously irradiated by condensed laser beams for memory readout in the range of approximately from 10 to 14 mW, driving the medium at a linear speed of 3.0 m/sec, to carry out local annealing treatment of only the magnetic films on the guide grooves. By this treatment, the magnetism of the magnetic films on the guide grooves was caused to deteriorate so that any domain wall energy was not accumulated at this part. From among the regions having been subjected to the local annealing treatment by making laser power variable in this way, spots which were optimum from the viewpoints of gaps and jitter value were picked up to evaluate recording and readout performance.

The recording was performed in the following way: By modulating a magnetic field at about ±200 Oe while irradiating the medium directly by laser light, a pattern of upward magnetized regions and downward magnetized regions corresponding to the modulation of the magnetic field was transferred from the memory auxiliary layer in course of cooling after heating to the Curie temperature or higher of the memory layer.

To select optimum recording power, the laser power was made variable in the range of approximately from 2 to 8 mW and an optimum value was selected. To perform the readout, the laser power was likewise made variable in the range of approximately from 1 to 4 mW, and an optimum value was selected. As the result, the optimum values of anneal power, recording power and readout power in this Example were 12.6 mW, 5.0 mW and 2.4 mW, respectively. Accordingly, using these optimum conditions, the state of jitter value and lack of recording in the tone pattern was measured in the range of from 0.07 to 3.0 μm in mark length. As the result, in Sample 1, the minimum memory mark length at which any lack of memory did not occur and jitter characteristics were also good was found to be 0.08 μm.

Meanwhile, the MsHc in the memory layer in this Example was measured on a different sample prepared using a glass substrate. Films were formed under the same conditions as those for the sample for dynamic-property evaluation except that the magnetic layer used in the memory layer was in a layer thickness of 100 nm. Also, since in the construction of the sample for dynamic-property evaluation the both sides of the memory layer were in the state the magnetic layers came in contact, an Si film was provided in a layer thickness of 10 nm on each side of the memory layer and on each side thereof an SiN protective layer of 30 nm thick was further provided in sandwich construction.

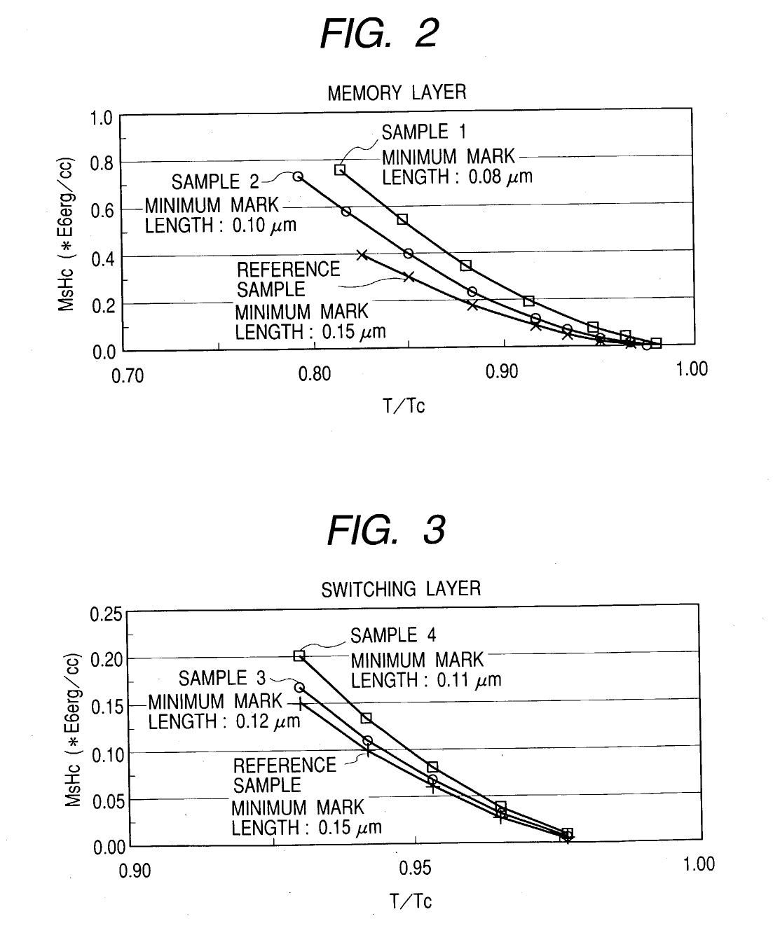

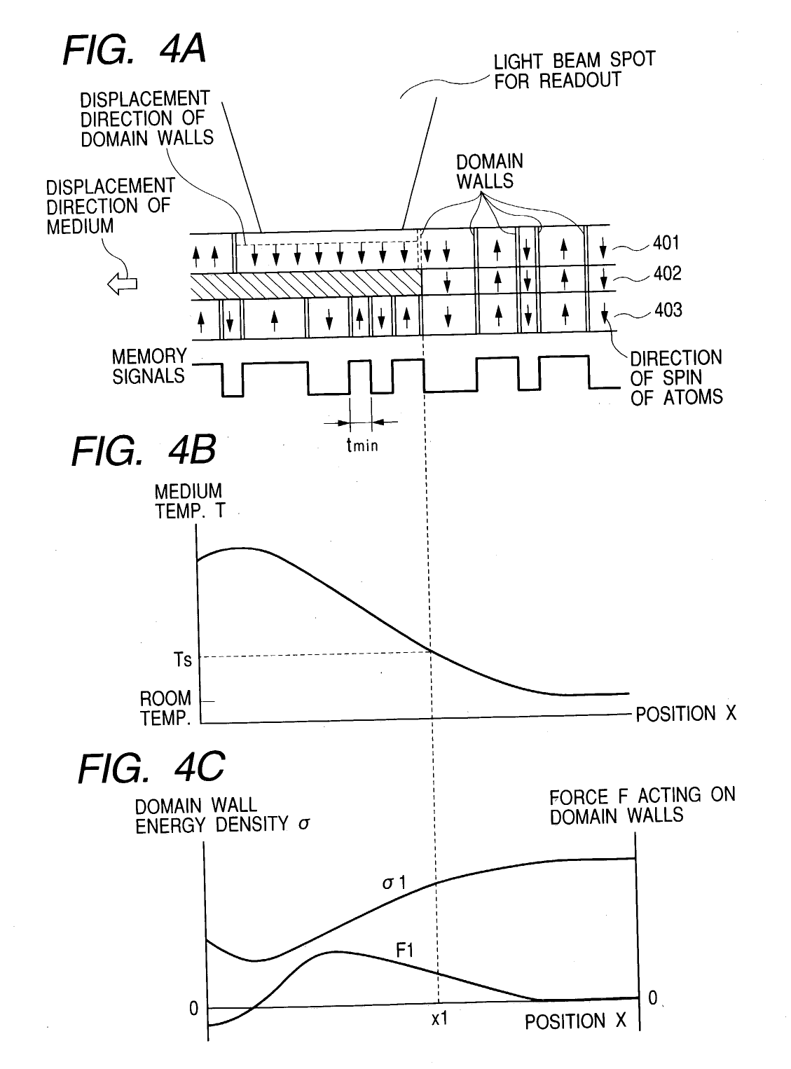

Before the measurement of MsHc, the medium was initialized with a bulk eraser. Thereafter, the temperature dependence of saturation magnetization Ms was measured with a vibrating-sample magnetic-force meter VSM; and the temperature dependence of coercive force Hc, with a magneto-optic effect measuring instrument. The values of saturation magnetization Ms and coercive force Hc which were found through these two courses of measurement were multiplied to find the product, and the temperature T was standardized by the Curie temperature Tc of the magnetic layers (memory layer and switching layer), followed by curve-fitting according to a quadratic polynomial. The results are shown in FIG. 2.

Next, a sample was prepared in the same manner as Sample 1 except that conditions for forming the memory layer, in particular, the Kr gas flow rate (pressure was changed keeping the conductance constant) and the number of revolutions of the substrate holder were changed (this sample is designated as Sample 2). The MsHc of the memory layer in this case was smaller than that of the memory layer of Sample 1 (see FIG. 2), and the minimum memory mark length was 0.10 μm, which was larger than that of Sample 1.

A sample was further prepared in the same manner as Sample 1 except that conditions for forming the memory layer were changed and the sputtering was carried out using Ar gas (this sample is designated as Reference Sample). The MsHc of the memory layer of this sample was smaller than those of the memory layer of Samples 1 and 2 (see FIG. 2), and the minimum memory mark length was 0.15 μm, which was fairly larger than those of Samples 1 and 2 and was about the typical value of conventional magneto-optic recording mediums.

The relationship between the MsHc and the minimum memory mark length of the switching layer was also examined in the same manner as that of the memory layer.

A sample was prepared in the same manner as Reference Sample except that conditions for forming the switching layer were changed, in particular, the sputtering gas, Ar gas was changed for Kr gas (this sample is designated as Sample 3). The MsHc of the switching layer in this case was larger than that of the switching layer of Reference Sample (see FIG. 3), and the minimum memory mark length was 0.12 μm, which was smaller than that of Reference Sample.

Next, a sample was prepared in the same manner as Sample 3 except that conditions for forming the switching layer, in particular, the Kr gas flow rate (pressure was changed keeping the conductance constant) and the number of revolutions of the substrate holder were changed (this sample is designated as Sample 4). The MsHc of the switching layer in this case was larger than that of the switching layers of Reference Sample and Sample 3 (see FIG. 3), and the minimum memory mark length was 0.11 μm, which was smaller than that of Reference Sample and Sample 3.

Finally, a switching layer was formed under the same conditions as those for Sample 3 and a memory layer was formed under the same conditions as those for Sample 1 to prepare a sample. As the result, in its recording and readout performance, any lack of memory did not occur up to marks of 0.07 μm in size and the jitter characteristics were also good, bringing about the best results in this Example.

The above results are shown together in Table 1 together with fitting equations. The minimum memory mark length becomes smaller with an increase in MsHc. Taking account of the fact that the minimum memory mark length of Reference Sample is the typical value of conventional magneto-optic recording mediums, a minimum memory mark length superior to the typical value of conventional magneto-optic recording mediums can be maintained as long as y≧15.8(x−1)² in the memory layer and y≧37.1(x−1)² in the switching layer. Here, x=T(K)/Tc(K) and y=MsHc(10⁶ erg/cc).

TABLE 1

| | | |
|---|---|---|
| Fitting equation | Sample | Min. memory mark length |

Recording Layer

| | | |
|---|---|---|
| y = 17.1(x − 1)² | Sample 1 | 0.08 μm |
| y = 15.8(x − 1)² | Sample 2 | 0.10 μm |
| y = 11.8(x − 1)² | Ref. | 0.15 μm |
| | Sample | |

Switching Layer

| | | |
|---|---|---|
| y = 44.5(x − 1)² | Sample 4 | 0.11 μm |
| y = 37.1(x − 1)² | Sample 3 | 0.12 μm |
| y = 33.4(x − 1)² | Ref. | 0.15 μm |
| | Sample | |

To form the memory layer and the switching layer, Xe gas may also be used besides the Kr gas. In the magneto-optic recording medium of the present invention, without limitation to the changes in plane of polarization which are produced by the magneto-optic effect, different changes produced by the displacement of domain walls may also be detected and read out.

As described above, according to the present invention, taking note of the MsHc as the magnetic properties of magnetic films, this MsHc is used as a parameter for optimizing magneto-optic recording mediums. This makes it possible to provide a magneto-optic recording medium having dramatically been improved in linear recording density through the improvement in the MsHc, compared with conventional magneto-optic recording mediums.

What is claimed is:

1. A magneto-optic recording medium comprising:
a substrate; and
a memory layer which holds information, provided on the substrate,
wherein the product of saturation magnetization Ms and coercive force Hc, MsHc (10⁶ erg/cc), of the memory layer is 15.8 (T/Tc−1)² or more where temperature is represented by T (K) and Curie temperature of the memory layer by Tc (K).

2. The magneto-optic recording medium according to claim 1, wherein the memory layer is a magnetic film comprising an amorphous rare earth-transition metal alloy, formed by sputtering carried out using Kr gas.

3. The magneto-optic recording medium according to claim 1, which further comprises a readout layer comprising a vertically magnetized film having a relatively smaller domain wall coercive force than the memory layer, and a switching layer comprising a magnetic film having a lower Curie temperature than the readout layer and the memory layer, provided between the readout layer and the memory layer.

4. The magneto-optic recording medium according to claim 3, wherein the switching layer is a magnetic film comprising an amorphous rare earth-transition metal alloy, formed by sputtering carried out using Kr gas.

5. The magneto-optic recording medium according to claim 3, wherein the product of saturation magnetization Ms and coercive force Hc, MsHc (10⁶ erg/cc), of the switching layer is 37.1 (T/Tc−1)² or more where temperature is represented by T (K) and Curie temperature of the switching layer by Tc (K).

6. The magneto-optic recording medium according to claim 3, wherein, at both sides of a memory track, the coupling attributable to exchange interaction in the film plane direction in the readout layer, the switching layer and the memory layer stands cut or lessened.
